(19) United States
(12) Patent Application Publication
(10) Pub. No.: US 2017/0092210 A1
(43) Pub. Date: Mar. 30, 2017

(54) DEVICES AND METHODS FOR MITIGATING VARIABLE REFRESH RATE CHARGE IMBALANCE

(71) Applicant: Apple Inc., Cupertino, CA (US)

(72) Inventors: Christopher P. Tann, San Jose, CA (US); Chaohao Wang, Sunnyvale, CA (US); David S. Zalatimo, San Jose, CA (US); Guy Cote, San Jose, CA (US); Brijesh Tripathi, San Jose, CA (US)

(21) Appl. No.: 14/866,539

(22) Filed: Sep. 25, 2015

(51) Int. Cl. G09G 3/36

(52) U.S. Cl. CPC G09G 3/3614; G09G 2330/021

(57) ABSTRACT

Devices and methods for reducing and/or substantially eliminating pixel charge imbalance due to variable refresh rates are provided. By way of example, a method includes providing a first frame of image data via a processor to a plurality of pixels of the display during a first frame period corresponding to a first refresh rate, and providing a second frame of image data to the plurality of pixels of the display during a second frame period corresponding to a second refresh rate. The method further includes dividing the first frame period into a first frame sub-period and a second frame sub-period, and driving the plurality of pixels of the display with the first frame of image data during the first frame sub-period and the second frame sub-period.

### BACKGROUND

The present disclosure relates generally to electronic displays utilizing variable refresh rates, and more particularly, to inversion imbalance compensation in electronic displays utilizing variable refresh rates.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Generally, an electronic display may enable a user to perceive visual representations of information by successively writing frames of image data to a display panel of the electronic display. More specifically, a frame of image data may be displayed by applying positive polarity voltages and/or negative polarity voltages to the pixels in the display panel over successive frame periods. For example, in a column inversion technique, positive polarity voltages may be applied to odd numbered columns and negative polarity voltages may be applied to even numbered columns to display a first frame of image data or first set of consecutive frames of image data. Subsequently, negative polarity voltages may be applied to the odd numbered columns and positive polarity voltage may be applied to the even numbered columns to display a second frame of image data or second set of consecutive frames of image data that occur after the first set of consecutive frames of image data. Similarly, when utilizing a dot inversion and/or pixel inversion technique, the applied voltage to the pixels of the display may alternate between a positive polarity voltage and a negative polarity voltage on a pixel by pixel basis for odd frames and even frames, respectively.

As used herein, “refresh rate” may refer to the frequency (e.g., in hertz [Hz]) at which frames of image data (e.g., first and second frames of image data) are written to an electronic display, or “refresh rate” may refer to the number of times that an image is refreshed per second. Accordingly, adjusting the refresh rate of an electronic device may adjust the power consumed by the electronic display. For example, when the refresh rate is higher, the power consumption may also be higher. On the other hand, when the refresh rate is lower, the power consumption may also be lower.

Indeed, in some instances, the refresh rate may be variable even between successively displayed frames of image data. For instance, continuing with the above example, the first frame of image data may be displayed with a refresh rate of 60 Hz and the second frame of image data may be displayed with a refresh rate of 30 Hz. As such, the negative polarity voltages may be applied to the odd numbered columns or odd pixels for twice as long as the positive polarity voltages. Similarly, the positive polarity voltage may be applied to the even numbered columns or even pixels for twice as long as the negative polarity voltages. However, since the duration the opposite polarity voltages are applied to the display panel may be different when the refresh rate is variable, an inversion imbalance may be accumulated in the display panel and reduce image quality. It may be useful to provide techniques to mitigate pixel charge imbalance in electronic displays utilizing variable refresh rates.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Devices and methods for reducing and/or substantially eliminating pixel charge imbalance due to variable refresh rates are provided. By way of example, a method includes providing a first frame of image data via a processor to a plurality of pixels of the display during a first frame period corresponding to a first refresh rate, and providing a second frame of image data to the plurality of pixels of the display during a second frame period corresponding to a second refresh rate. The method further includes dividing the first frame period into a first frame sub-period and a second frame sub-period, and driving the plurality of pixels of the display with the first frame of image data during the first frame sub-period and the second frame sub-period.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device including display control circuitry, in accordance with an embodiment;

FIG. 2 is a perspective view of a notebook computer representing an embodiment of the electronic device of FIG. 1, in accordance with an embodiment;

FIG. 3 is a front view of a hand-held device representing another embodiment of the electronic device of FIG. 1, in accordance with an embodiment;

FIG. 4 is a front view of another hand-held device representing another embodiment of the electronic device of FIG. 1, in accordance with an embodiment;

FIG. 5 is block diagram of the display control circuitry included in the electronic device of FIG. 1, in accordance with an embodiment;

FIG. 6 is a diagram of a two dimensional grid of pixels utilizing a pixel inversion technique, in accordance with an embodiment;

FIG. 7 is a diagram of a two dimensional grid of pixels utilizing frame repeat mitigation, in accordance with an embodiment;

FIG. 8 is a diagram of a two dimensional grid of pixels utilizing frame repeat mitigation, in accordance with an embodiment;

FIG. 9 is a diagram of a two dimensional grid of pixels utilizing frame repeat mitigation, in accordance with an embodiment;

FIG. 10 is a plot diagram illustrating pixel charge versus time and notating the frame repeat mitigation, in accordance with an embodiment; and

FIG. 11 is a plot diagram illustrating pixel charge versus time and notating the frame repeat mitigation, in accordance with an embodiment; and

FIG. 12 is a plot diagram illustrating a cadence of variable refresh rates and utilizing frame repeat mitigation, in accordance with an embodiment; and

FIG. 13 is a flow diagram illustrating an embodiment of a process useful in reducing and/or substantially eliminating voltage or pixel charge imbalance due to variable refresh rates, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure generally relate to electronic displays utilizing variable refresh rates, methods for reducing and/or substantially eliminating voltage or pixel charge imbalance, and, by extension, image artifacts that may be caused by variable refresh rates. In certain embodiments, a timing controller (TCON) or other processing device may be used to provide a frame of image data with a total frame period, and to divide the total frame period into two or more substantially similar frames of image data provided during frame the two or more sub-periods (e.g., subdivisions of the total frame period). Indeed, the present techniques of dividing the total frame period into sub-periods may be referred to as “frame repeat mitigation,” as the active frame of image data (e.g., odd frames and/or the even frames of image data) may be refreshed at least twice per total frame period as opposed to only once per total frame period.

Indeed, in some embodiments, the TCON may perform the present frame repeat mitigation techniques (e.g., dividing total frame period into two or more frame sub-periods) based on, for example, real-time (e.g., measured pixel charge imbalance accumulation data) pixel charge imbalance accumulation data or historical pixel charge imbalance accumulation data (e.g., data models of pixel charge imbalance accumulation generated from data measured or approximated over time). That is, in some embodiments, the TCON 44 may divide a total frame period into the two or more frame sub-periods based on, for example, a pixel charge threshold, and may repeat or alter the frame of data provided to the pixels of the display when the pixel charge approaches a pixel charge value of a positive polarity pixel charge threshold value or a negative polarity pixel charge threshold value. In this way, the present embodiments may reduce and/or substantially eliminate voltage and/or pixel charge imbalance accumulated on the pixels of the display, and, by extension, may reduce and/or substantially eliminate image artifacts based thereon that may become apparent on the display 18 when utilizing variable refresh rates.

With these features in mind, a general description of suitable electronic devices useful in reducing and/or substantially eliminating voltage or pixel charge imbalance due to variable refresh rates is provided. Turning first to FIG. 1, an electronic device 10 according to an embodiment of the present disclosure may include, among other things, one or more processor(s) 12, memory 14, nonvolatile storage 16, a display 18, input structures 22, an input/output (e.g., I/O) interface 24, network interfaces 26, display control logic 28, and a power source 29. The various functional blocks shown in FIG. 1 may include hardware elements (e.g., including circuitry), software elements (e.g., including computer code stored on a computer-readable medium) or a combination of both hardware and software elements. It should be noted that FIG. 1 is merely one example of a particular implementation and is intended to illustrate the types of components that may be present in electronic device 10.

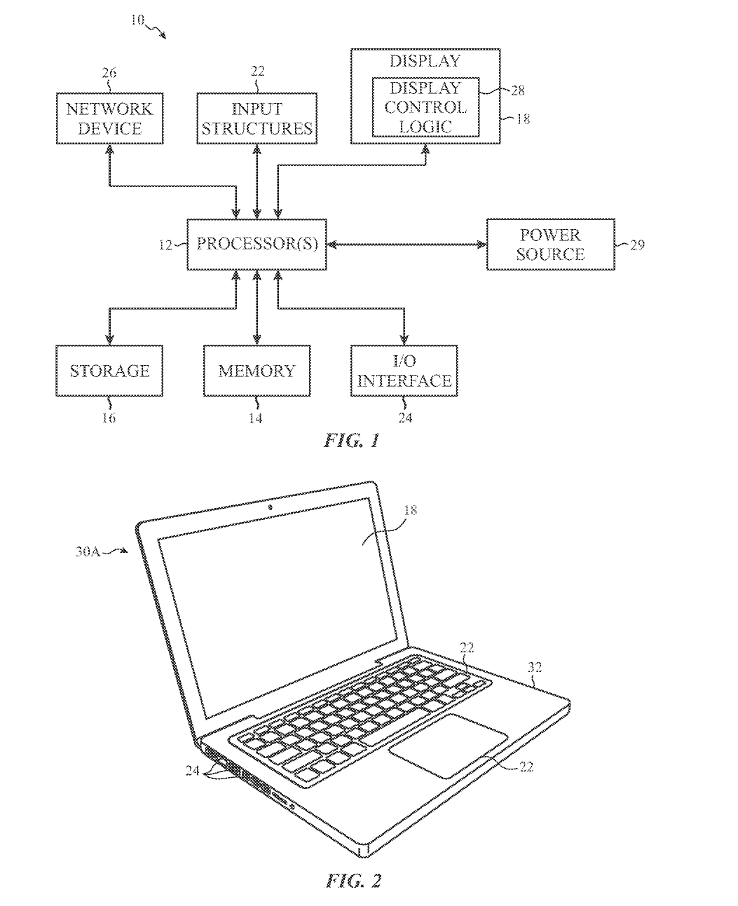

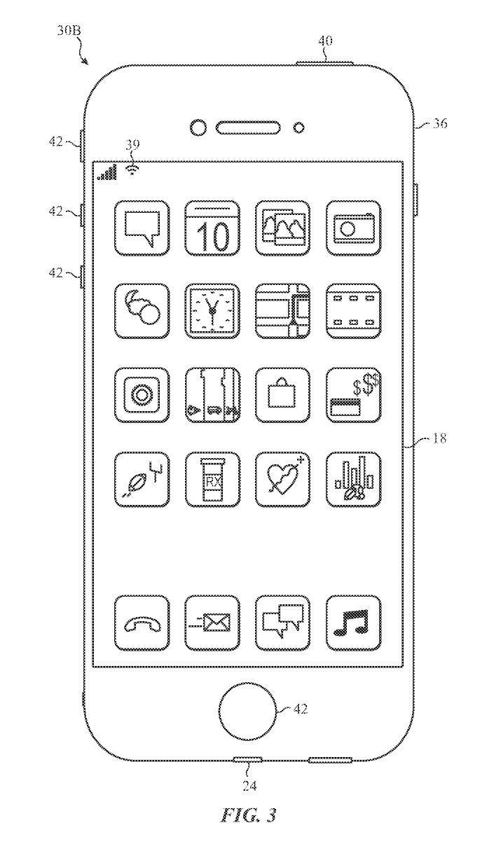

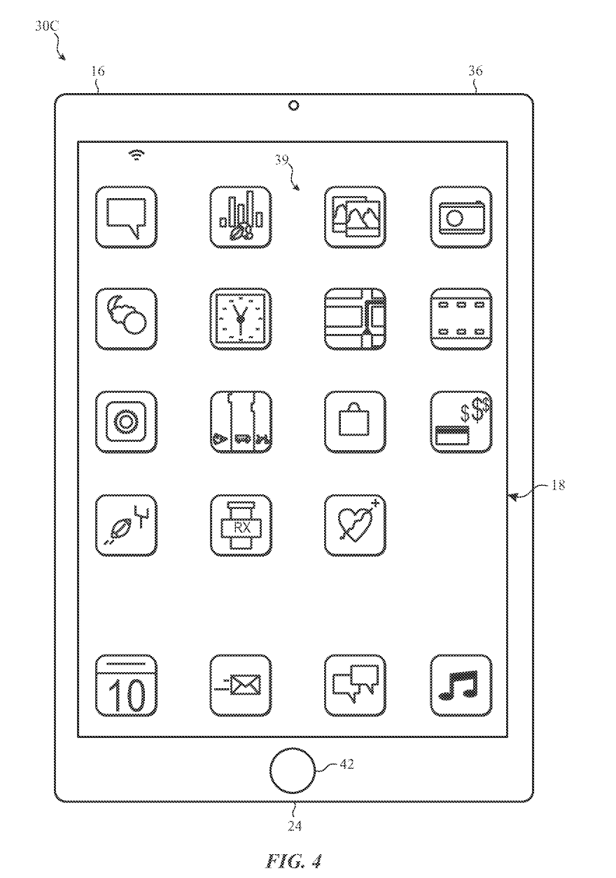

By way of example, the electronic device 10 may represent a block diagram of the notebook computer depicted in FIG. 2, the handheld device depicted in either of FIG. 3 or FIG. 4, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile memory 16 to perform various algorithms. Such programs or instructions executed by the processor(s) 12 may be stored in any suitable article of manufacture that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Also, programs (e.g., e.g., an operating system) encoded on such a computer program product may also include instructions that may be executed by the processor(s) 12 to enable the electronic device 10 to provide various functionalities.

In certain embodiments, the display 18 may be a liquid crystal display (e.g., LCD), which may allow users to view images generated on the electronic device 10. In some embodiments, the display 18 may include a touch screen, which may allow users to interact with a user interface of the electronic device 10. Furthermore, it should be appreciated that, in some embodiments, the display 18 may include one or more organic light emitting diode (e.g., OLED) displays, or some combination of LCD panels and OLED panels.

The input structures 22 of the electronic device 10 may enable a user to interact with the electronic device 10 (e.g., e.g., pressing a button to increase or decrease a volume level). The I/O interface 24 may enable electronic device 10 to interface with various other electronic devices, as may the network interfaces 26. The network interfaces 26 may include, for example, interfaces for a personal area network (e.g., PAN), such as a Bluetooth network, for a local area network (e.g., LAN) or wireless local area network (e.g., WLAN), such as an 802.11x Wi-Fi network, and/or for a wide area network (e.g., WAN), such as a 3^{rd} generation (e.g., 3G) cellular network, 4^{th} generation (e.g., 4G) cellular network, or long term evolution (e.g., LTE) cellular network. The network interface 26 may also include interfaces for, for example, broadband fixed wireless access networks (e.g., WiMAX), mobile broadband Wireless networks (e.g., mobile WiMAX), and so forth. As further illustrated, the electronic device 10 may include a power source 29. The power source 29 may include any suitable source of power, such as a rechargeable lithium polymer (e.g., Li-poly) battery and/or an alternating current (e.g., AC) power converter.

In certain embodiments, the display 18 may further include display control logic 28. The display control logic 28 may be coupled to the processor(s) 12. The display control logic 28 may be used to receive a data stream, for example, from processor(s) 12, indicative of an image to be represented on display 18. The display control logic 28 may be an application specific integrated circuit (e.g., ASIC), or any other circuitry for adjusting image data and/or generate images on display 18. As will be further appreciated, the display control logic 28 may also include a timing controller (TCON) that may be useful in dividing the period (e.g., frame period) in which data is provided to the display 18 per frame period, and thereby reducing and/or substantially eliminating any voltage or pixel charge imbalance that may possibly occur on the display 18 due to utilizing variable refresh rates.

In certain embodiments, the electronic device 10 may take the form of a computer, a portable electronic device, a wearable electronic device, or other type of electronic device. Such computers may include computers that are generally portable (e.g., such as laptop, notebook, and tablet computers) as well as computers that are generally used in one place (e.g., such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 30A, is illustrated in FIG. 2 in accordance with one embodiment of the present disclosure. The depicted computer 30A may include a housing or enclosure 32, a display 18, input structures 22, and ports of an I/O interface 24. In one embodiment, the input structures 22 (e.g., such as a keyboard and/or touchpad) may be used to interact with the computer 30A, such as to start, control, or operate a GUI or applications running on computer 30A. For example, a keyboard and/or touchpad may allow a user to navigate a user interface or application interface displayed on display 18.

FIG. 3 depicts a front view of a handheld device 30B, which represents one embodiment of the electronic device 10. The handheld device 34 may represent, for example, a portable phone, a media player, a personal data organizer, a handheld game platform, or any combination of such devices. By way of example, the handheld device 34 may be a model of an iPod® or iPhone® available from Apple Inc. of Cupertino, Calif.

The handheld device 30B may include an enclosure 36 to protect interior components from physical damage and to shield them from electromagnetic interference. The enclosure 36 may surround the display 18, which may display indicator icons 39. The indicator icons 38 may indicate, among other things, a cellular signal strength, Bluetooth connection, and/or battery life. The I/O interfaces 24 may open through the enclosure 36 and may include, for example, an I/O port for a hard wired connection for charging and/or content manipulation using a standard connector and protocol, such as the Lightning connector provided by Apple Inc., a universal service bus (e.g., USB), or other similar connector and protocol.

User input structures 40 and 42, in combination with the display 18, may allow a user to control the handheld device 30B. For example, the input structure 40 may activate or deactivate the handheld device 30B, one of the input structures 42 may navigate user interface to a home screen, a user-configurable application screen, and/or activate a voice-recognition feature of the handheld device 30B, while other of the input structures 42 may provide volume control, or may toggle between vibrate and ring modes. Additional input structures 42 may also include a microphone may obtain a user's voice for various voice-related features, and a speaker to allow for audio playback and/or certain phone capabilities. The input structures 42 may also include a headphone input to provide a connection to external speakers and/or headphones.

FIG. 4 depicts a front view of another handheld device 30C, which represents another embodiment of the electronic device 10. The handheld device 30C may represent, for example, a tablet computer, or one of various portable computing devices. By way of example, the handheld device 30C may be a tablet-sized embodiment of the electronic device 10, which may be, for example, a model of an iPad® available from Apple Inc. of Cupertino, Calif.

Turning now to FIG. 5, which illustrates the internal components of the display 18, and more specifically, the components that may be included as part of the display control logic 28. For example, as depicted, the display control logic 28 may include an image generating source 43, a timing controller (TCON) 44, and a display driver 52 (e.g., column driver or source driver). The image source 43 may generate image data and transmit the image data to the TCON 44. Accordingly, in some embodiments, the image generating source 43 may be the processor 18 and/or the image processing circuitry 27. Additionally, the TCON 44 may analyze the received image data and instruct the driver 52 to write a frame of image data to the pixels by applying a voltage to the display panel of the electronic display 18. As further illustrated, to facilitate the processing of the image data, the TCON 44 may, in some embodiments, include an internal processor 42 and internal memory 44. Specifically, the TCON 44 may utilize the internal processor 42 and internal memory 44 to analyze received image data to determine, for example, the magnitude of voltage to apply to each pixel to achieve the desired frame of image data to supply to the display driver 52. Additionally, the TCON 44 may analyze the received image data to determine the desired refresh rate at which to supply to the display driver 52.

In some embodiments, the TCON 44 may determine the desired refresh rate based on, for example, the number of vertical blank (Vblank) lines and/or active lines included in the image data. For example, when the display 18 displays frames of image data with a resolution of 2880×1800, the TCON 44 may instruct the driver 52 to display a first frame of image data at 60 Hz when the TCON 44 determines that the corresponding image data includes 52 vertical blank lines and 1800 active lines. Additionally, the TCON 44 may instruct the driver 52 to display a second frame of image data at 30 Hz when the TCON 44 determine that the corresponding image data includes 1904 vertical blank lines and 1800 active lines.

Since each row of pixels in the display 18 is successively written, the duration a frame of image data is displayed may include the number of active lines in corresponding image data. Additionally, when a vertical blank line in the corresponding image data is received, the displayed frame of image data may continue to be displayed. As such, the total duration a frame of image data is displayed may be described as the sum of the number of vertical blank lines and the number of active lines in the corresponding image data. To help illustrate, continuing with the above example, the duration the first frame of image data is displayed may be 1852 lines and the duration the second frame of image data is displayed may be 3704 lines. In other words, a line may be used herein to represent a unit of time.

As described above, the duration positive and negative voltages are applied to the pixels of the display 18 may cause a pixel charge imbalance to accumulate on the pixels of the display 18. As such, in some embodiments, the TCON 44 may utilize a counter 50 to keep track of the duration each sets of voltage polarities are held by incrementing and/or decrementing based on, for example, the time period of which the positive and negative polarity voltages are applied to the pixels of the display 18 per frame period, as well as the monitored net pixel charge accumulation on the pixels of the display 18. For example, the counter 50 may increment the number of lines included in image data when the corresponding frame of image data is displayed with the first set of voltage polarities (e.g., positive frame).

On the other hand, the counter 50 may decrement the number of lines included in image data when the corresponding frame of image data is displayed with the second set of voltage polarities (e.g., negative frame). Additionally or alternatively, the counter 50 may include a timer that keeps track of time each sets of voltage polarities are held, and may also track the pixel charge accumulation over time. Indeed, as will be further appreciated, the TCON 44 may reduce or substantially eliminate pixel charge imbalance accumulated on the pixels of the display 18 by dividing the frame period corresponding to the lower refresh rate and refreshing subsequent frames (e.g., twice per frame period) of image data using a set of voltage polarities that trends the counter value and the pixel charge toward a neutral value (e.g., zero pixel charge value).

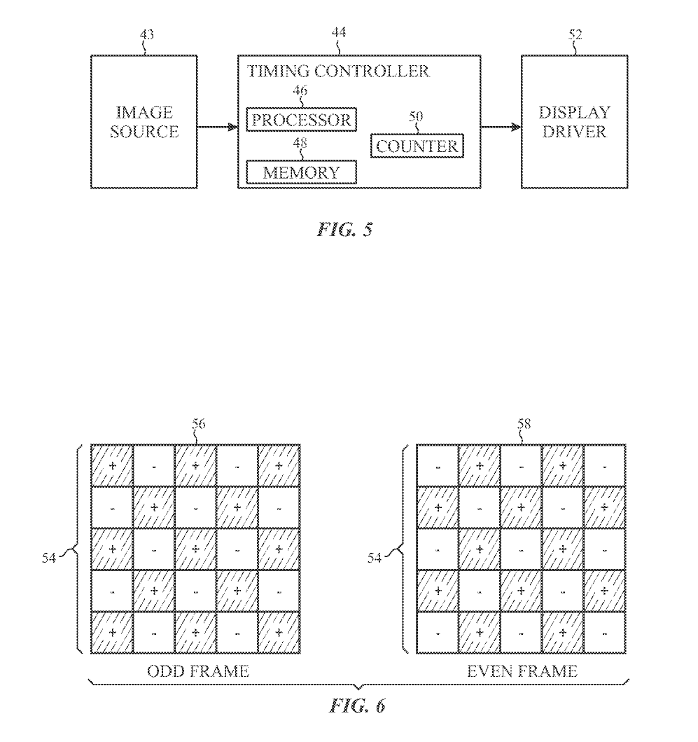

FIG. 6 illustrates a pixel inversion technique that may be used by the display 18. However, it should be appreciated that the techniques discussed herein may be applied in displays utilizing any inversion technique such as, for example, a column inversion technique, a line inversion technique, a frame inversion technique, and so forth. For example, an odd frame pixel grid 56 may be a portion of the display 18 and that utilizes a dot inversion and/or pixel inversion method. During the odd frame, the odd frame pixel grid 56 may include 5×5 pixels 54, each with a corresponding voltage applied to the pixels 54. The applied voltage to the pixels 54 of the display 18 may alternate between a positive voltage polarity (e.g., +Vₚᵢₓₑₗ) and a negative voltage polarity (e.g., −Vₚᵢₓₑₗ) on a pixel by pixel basis. For example, the top most row, the third row, and the fifth rows (e.g., rows 1, 3, and 5 of the odd frame pixel grid 56) may include a number of pixels 54 that may receive a positive voltage polarity (e.g., along columns 1, 3, and 5 of the pixel grid 56) and a negative voltage polarity (e.g., along columns 2 and 4 of the pixel grid 56). On the other hand, the second and fourth rows (e.g., rows 2 and 4 of odd frame pixel grid 56) may include five pixels 54 that receive a positive voltage polarity (e.g., along columns 2 and 4 of the pixel grid 56) and a negative voltage polarity (e.g., along columns 1, 3, and 5 of the even pixel grid 56).

As further illustrated in FIG. 6, during an even frame, rows 1, 3, and 5 of an even frame pixel grid 58 may include a number of pixels 54 that receive a positive voltage polarity (e.g., in columns 2 and 4 of the even frame pixel grid 58) and a negative voltage polarity (e.g., in columns 1, 3, and 5 of the even frame pixel grid 58). On the other hand, the second and fourth rows (e.g., rows 2 and 4 of the even frame pixel grid 58) may include five pixels 54 that receive a positive voltage (e.g., along columns 1, 3 and 5 of the even frame pixel grid 58) and a negative voltage (e.g., rows 2 and 4 of the even frame pixel grid 58) during the even frame. Specifically, during the even frame, each of the pixels 54 previously driven with a positive voltage polarity in the odd frame may be each then driven with negative voltage polarity, and vice versa.

It should be appreciated that the odd frame pixel grid 56 and the even frame pixel grid 58 as depicted in FIG. 6 may each represent a separate frame period. Indeed, in some embodiments, the odd frame pixel grid 56 and the even frame pixel grid 58 may each include a different refresh rate (e.g., variable refresh rate). For example, in one embodiment, the odd frame pixel grid 56 may be provided to the pixels 54 of the display 18 at a refresh rate of 60 Hz, while the even frame pixel grid 58 may be provided to the pixels 54 of the display 18 at a refresh rate of 30 Hz, and vice-versa. In another embodiment, the odd frame pixel grid 56 may be provided to the pixels 54 of the display 18 at a refresh rate of 120 Hz, while the even frame pixel grid 58 may be provided to the pixels 54 of the display 18 at a refresh rate of 120 Hz, and vice-versa.

However, because, for example, the odd frame pixel grid 56 and the even frame pixel grid 58 may be provided to the pixels 54 of the display 18 at different refresh rates, and, by extension, during frame periods of different durations, the pixel charge imbalance may accumulate on the pixels 54. This may lead to undesirable image artifacts becoming apparent on the display 18. For example, when the refresh rate is a reduced from, for example, 60 Hz to 30 Hz, displaying the next frame of image data at the reduced refresh rate (e.g., 30 Hz) may increase the pixel charge imbalance accumulated on the pixels 54 of the display 18 because the pixels 54 intended to be driven with a positive polarity voltage and/or a negative polarity voltage will be driven positively and/or negatively for a longer period of time at the reduced refresh rate (e.g., 30 Hz) as compared to the pixels 54 intended to be driven with a positive polarity voltage and/or a negative polarity voltage during, for example, a preceding or succeeding frame period at the normal refresh rate (e.g., 60 Hz).

Accordingly, in certain embodiments, to mitigate the pixel charge imbalance that may accumulate on the pixels 54, it may be useful to provide a frame of image data with a total frame period T, and to divide the total frame period T into two or more substantially similar frames of image data provided during frame sub-periods T₁ and T₂ (e.g., subdivisions of the total frame period T). Indeed, in one embodiment, the present techniques of dividing the total frame period T into sub-periods T₁ and T₂ may be referred to herein as “frame repeat mitigation,” as the active frame of image data (e.g., the odd frame pixel grid 56 and/or the even frame pixel grid 58) may be refreshed at least twice per total frame period T as opposed to only once per total frame period T. For example, in one embodiment, the total frame period T may be generally expressed as:

T=T₁+T₂, where T₁≠T₂ equation(1).

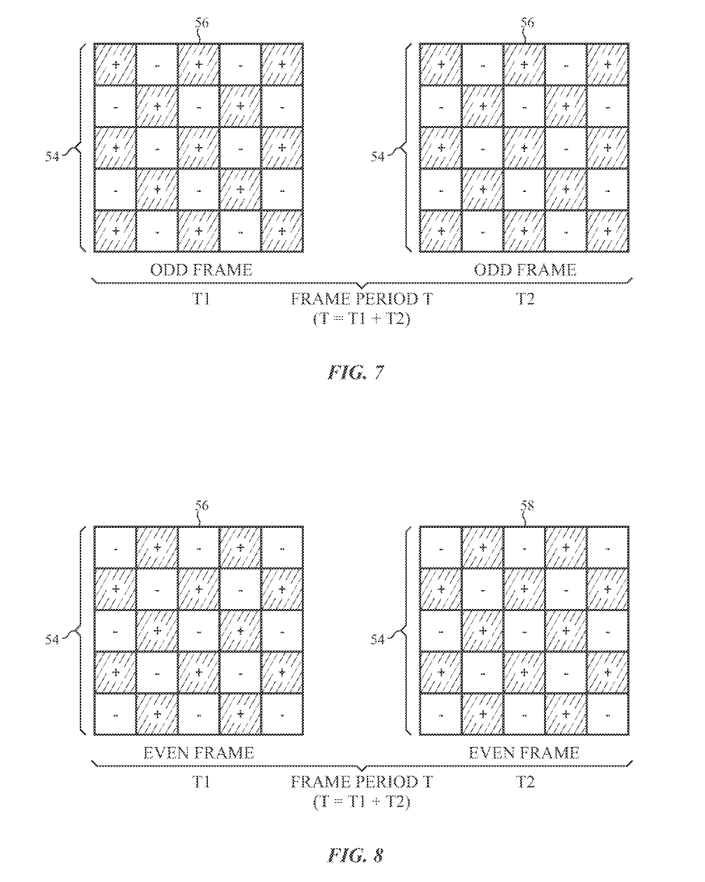

In some embodiments, as generally discussed above with respect to FIG. 5, the present frame repeat mitigation techniques (e.g., dividing total frame period T into frame sub-periods T₁ and T₂) may be performed based on, for example, real-time (e.g., measured pixel charge imbalance accumulation data) pixel charge imbalance accumulation data or historical pixel charge imbalance accumulation data (e.g., data models of pixel charge imbalance accumulation generated from data measured or approximated over time). That is, in some embodiments, the TCON 44 may divide a total frame period T into frame sub-periods T₁ and T₂ based on, for example, a pixel charge threshold (e.g., monitor how closely the real-time pixel charge is approaching a configurable or historical pixel charge threshold value), and may repeat or alter the frame of data provided to the pixels 54 of the display 18 when the pixel charge approaches a pixel charge value of a positive polarity pixel charge threshold value (e.g., or just less than the positive polarity pixel charge threshold value) or a negative polarity pixel charge threshold value (e.g., or just greater than the positive polarity pixel charge threshold value). Thus, as will be further described with respect to FIGS. 7-10, the present embodiments may reduce and/or substantially eliminate voltage and/or pixel charge imbalance of the pixels 54 of the display 18, and, by extension, reduce and/or substantially eliminate image artifacts based thereon that may become apparent on the display 18 when utilizing variable refresh rates (e.g., varying between 120 Hz, 90 Hz, 60 Hz, 45 Hz, 30 Hz, and so forth per frame period).

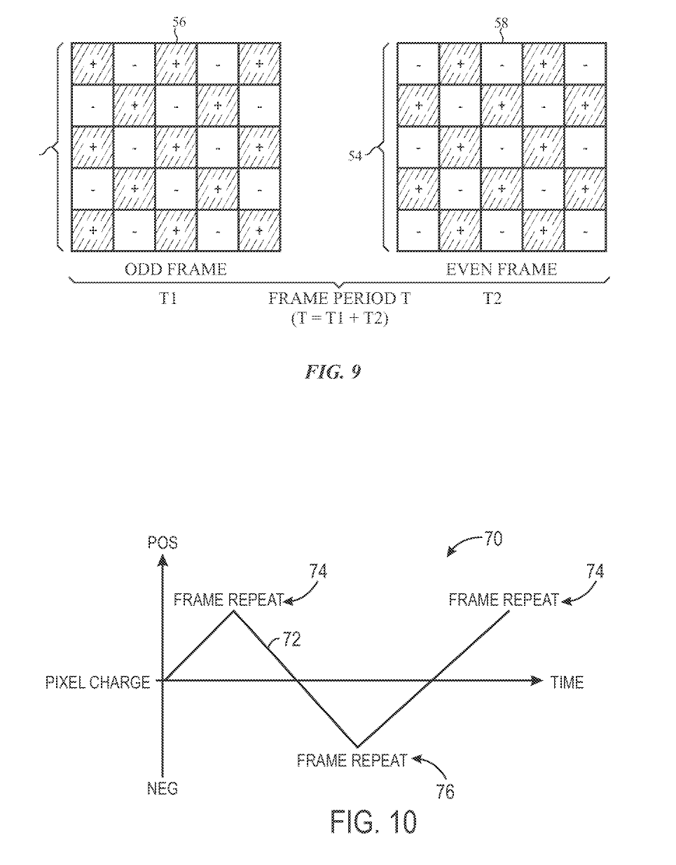

For example, as illustrated in FIGS. 7, 8, and 9, in certain embodiments, the TCON 44 may repeat a frame of image data by, for example, driving the pixels 54 with odd frames (e.g., positive frame) of image data during each of the frame sub-periods T₁ and T₂ positive when the accumulated pixel 54 charge (e.g., net accumulated pixel 54 charge) is approaching a negative polarity pixel charge threshold value as illustrated in FIG. 7. Similarly, the TCON 44 may repeat a frame of image data by, for example, driving the pixels 54 with even frames (e.g., negative frame) of image data during each of the frame sub-periods T₁ and T₂ positive when the accumulated pixel 54 charge (e.g., net accumulated pixel 54 charge) is approaching a positive polarity pixel charge threshold value as illustrated in FIG. 8. FIG. 9 illustrates that the TCON 44 may alter the polarity of the frame of image data (although the content of the frame of image data may remain the same) between the frame sub-periods T₁ and T₂ by, for example, driving the pixels 54 with odd frames (e.g., positive frame) of image data during the frame sub-period T₁, driving the pixels 54 with even frames (e.g., negative frame) of image data during the frame sub-period T₂, or vice-versa, based on, for example, the measured and/or modeled accumulated charge imbalance (e.g., positive polarity charges and/or negative polarity charges) on the pixels 54 of the display 18.

However, it should be appreciated that the examples illustrated in FIGS. 7, 8, and 9, respectively, are included merely for the purpose of illustration. Indeed, as delineated above with respect to equation (1), it should be appreciated that the frame sub-periods T₁ and T₂ may not be equal, as the total frame period T, and, by extension, the frame sub-periods T₁ and T₂, may vary with the variable refresh rates (e.g., varying between 120 Hz, 60 Hz, 45 Hz, 30 Hz, and so forth per frame period) of the display 18. Indeed, in some embodiments, the former frame sub-period T₁ (e.g., as opposed to the latter frame sub-period T₂) may be set to the minimum frame period (e.g., Tₘᵢₙ) of the display 18. For example, in one embodiment, similar to equation (1), the total frame period T may be further expressed as:

$$T = \frac{1}{Refresh Rate ( Hz )} = {T}_{1} + {T}_{2} , where {T}_{1} = {T}_{min} . \qquad equation ( 2 )$$

Thus, as may be appreciated from equation (2), as the refresh rate varies, for example, between 60 Hz and 30 Hz or between 120 Hz and 60 Hz, the total frame period T may vary, for example, between 16.66 milliseconds (ms) and 33.33 ms or between 8.33 ms and 16.66 ms. Therefore, without the present frame repeat mitigation techniques (e.g., dividing the total frame period T into frame sub-periods T₁ and T₂ and refreshing the current frame of image data at least twice per total frame period T), a net positive polarity charge or a net negative polarity charge may accumulate on the pixels 54 when the frame period corresponding to the greater of, for example, 16.66 ms and 33.33 ms or 8.33 ms and 16.66 ms includes positive or negative polarity voltages.

For example, because the TCON 44 may divide the total frame period T into frame sub-periods T₁ and T₂ and refresh the frame of image data at least twice per total frame period T, when the pixels 54 are intended to be driven to a +3V voltage and a −3V voltage, the +3V (positive polarity) voltage may be actually driven at 3.0V as opposed to, for example, +3.1V. Similarly, the −3V (negative polarity) voltage may actually be driven at −3.0V as opposed to, for example, −2.9V. Thus, the present frame repeat mitigation techniques may reduce and/or substantially eliminate accumulated voltage and/or pixel charge imbalance on the pixels 54 of the display 18 when utilizing variable refresh rates, and, by extension, may reduce and/or substantially eliminate image artifacts based thereon that may become apparent on the display 18.

Turning now to FIG. 10, which illustrates a pixel charge plot 70 generated, for example, by way of the TCON 44 and the counter 50. The pixel charge plot 70 is plotted as a function pixel 54 charge over time. As depicted by the pixel charge plot 70 of FIG. 10, when the pixel charge 72 reaches a positive polarity pixel charge threshold value 74 (e.g., corresponding to each of the positive polarity voltage driven pixels 54 per frame period), a negative polarity pixel charge threshold value 76 (e.g., corresponding to each of the negative polarity voltage driven pixels 54 per frame period), or other pixel charge threshold value, the TCON 44 may divide the total frame period T into frame sub-periods T₁ and T₂ and repeat or alter the frame of image data at least twice per the total frame period T to mitigate the occurrence of pixel charge imbalance accumulation.

In certain embodiments, the positive polarity pixel charge threshold value 74 and the negative polarity pixel charge threshold value 76 may be configurable values or model-based values. Specifically, as previously discussed above with respect to FIG. 5, the TCON 44 may include the counter 50 that is incremented and/or decremented with each frame of a data provided to the pixels 54 of the display 18 until a configurable charge threshold on the individual pixels 54 of the display 18 is reached. Once the configurable pixel charge threshold value (e.g., positive polarity threshold value 74, negative polarity threshold value 76) is reached, the TCON 44 may divide the total frame period T into frame sub-periods T₁ and T₂ and repeat or alter the frame of image data at least twice per the total frame period T based on, for example, the pixel charge imbalance accumulation.

Indeed, as further illustrated in FIG. 10, by repeating or altering (e.g., driving the pixels 54 with two or more odd frames, two or more even frames, or with one odd frame and one even frame respectively during the frame sub-periods T₁ and T₂) the frame of image data at least twice per the total frame period T, the pixel charge 72 may decrease toward a neutral charge value (e.g., approaching an approximately zero value net charge) once the pixel charge 72 reaches the positive polarity pixel charge threshold value 74 and increase toward the neutral charge value (e.g., approaching an approximately zero value net charge) once the pixel charge 72 reaches the negative polarity pixel charge threshold value 76. Thus, these techniques may thus reduce and/or substantially eliminate voltage and/or charge imbalance of the pixels 54 of the display 18 when utilizing variable refresh rates, and, by extension, may reduce and/or substantially eliminate image artifacts based thereon that may become apparent on the display 18.

In certain embodiments, in addition to the TCON 44 monitoring the pixel 54 charge imbalance accumulated over time and performing the frame repeat mitigation techniques discussed above based thereon, it may be further useful for the TCON 44 to monitor the cadence (e.g., rhythmic pattern) of the frames of image data at the variable refresh rates) provided to the pixels 54 of the display 18. For example, FIG. 11 illustrates a plot 80, which depicts an unbalanced cadence between the refresh rates and/or periods “X+,” “Y−,” “X+,” and “Y−.” For the purpose of illustration, “X” and “Y” may include refresh rates of different values (e.g., 60 Hz and 30 Hz, respectively). Specifically, the plot 80 may be considered unbalanced because the frame periods corresponding to the “Y−” refresh rate may be longer than the frame periods corresponding to the “X+” refresh rate. Furthermore, because the frame periods corresponding to the “Y−” refresh rate and/or period may occur immediately following the frame periods corresponding to the “X+” refresh rate and/or period, pixel 54 charges (e.g., during the negative frame in the present illustration) may accumulate on the pixels 54 during the frame periods corresponding to the “Y−” refresh rate and/or period.

Accordingly, in certain embodiments, it may be useful for the TCON 44 to adjust the cadence (e.g., rhythmic pattern of the frames of image data at the variable refresh rates) of the frames of image data as depicted in FIG. 11. For example, plot 82 depicts a balanced cadence between the refresh rates and/or periods “X+,” “X−,” “Y+,” and “Y−.” Indeed, as illustrated by the plot 82 of FIG. 11, the frame periods corresponding to the “X+” and “X−” refresh rates and/or periods may occur successively, and, likewise, the frame periods corresponding to the “Y+” and “Y−” refresh rates and/or periods may occur successively. In this way, the pixels 54 may be driven for substantially equal periods of time during the positive and negative frames at the refresh rate “X” (e.g., 60 Hz, 90 Hz, 120 Hz) and the refresh rate “Y” (e.g., 30 Hz, 45 Hz, 60 Hz).

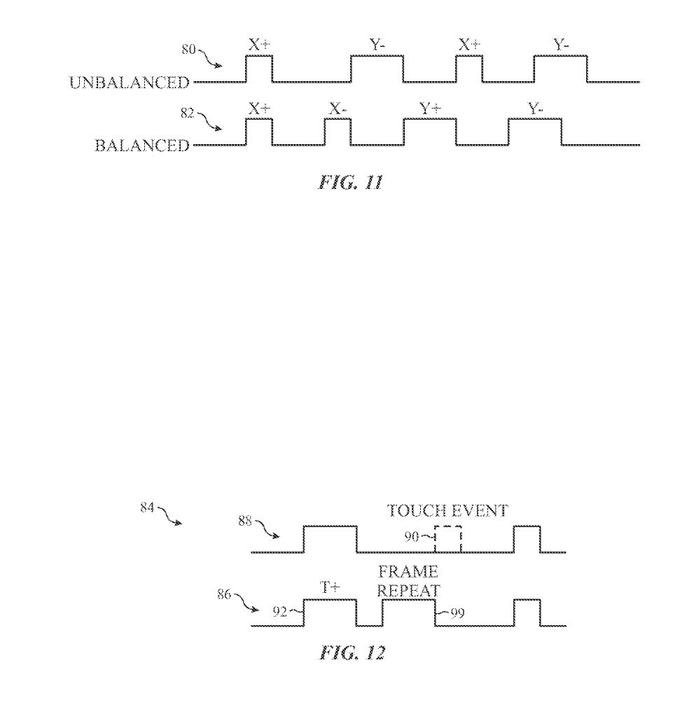

In other embodiments, it may be useful to apply the present frame repeat mitigation techniques (e.g., dividing the total frame period T into frame sub-periods T₁ and T₂ and refreshing the current frame of image data at least twice per total frame period T) during the times the display 18 performs touch scans (e.g., a time period where the display 18 scans for a touch on the display 18) between the times that the display 18 is refreshed with frames of image data. FIG. 12 illustrates an example of the present frame repeat mitigation techniques applied during the times the display 18 performs touch scans by way of plots 84 and 86. For example, as illustrated by plot 84 of FIG. 12, a touch event 90 may, in some embodiments, be detected as an additional generated frame of data (e.g., in addition to the frame of image data generated during the frame period 88).

Thus, in certain embodiments, as illustrated in plot 86, the TCON 44 may divide the total frame period T into frame sub-periods T₁ (e.g., as illustrated by the frame period 92) and T₂ (e.g., as illustrated by the frame period 94) and refresh the pixels 54 with a frame of image data opposite the voltage polarity of the frame of image data provided to the pixels 54 during, for example, the frame sub-period 92. For example, as depicted by the plot 86, if a positive frame is provided during the frame period 92 (e.g., “T₊”), then a negative frame may be provided during the frame period 94 immediately following the frame period 92. This may thus reduce the possibility of image artifacts becoming apparent on the display 18 due to, for example, the touch event 90 as illustrated in the plot 84 of FIG. 12.

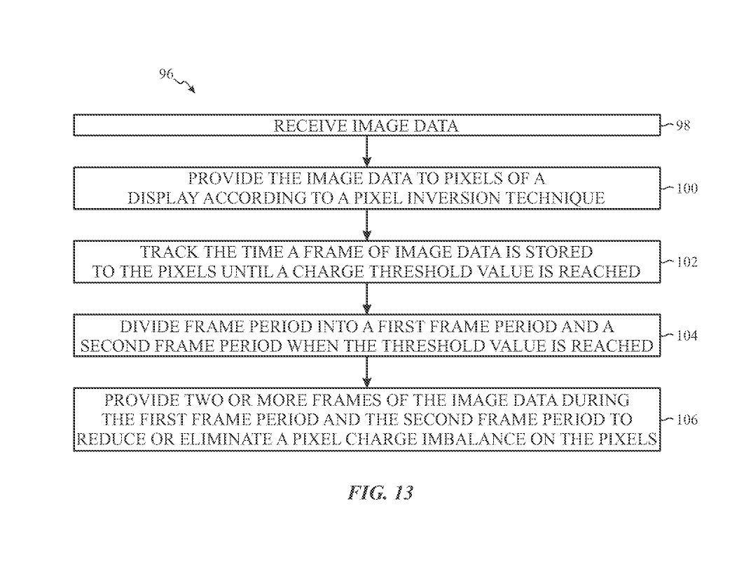

Turning now to FIG. 13, a flow diagram is presented, illustrating an embodiment of a process 96 useful in reducing and/or substantially eliminating voltage or pixel charge imbalance due to variable refresh rates by using, for example, the TCON 44 depicted in FIG. 5 and/or the one or more processor(s) 12 included in FIG. 1. The process 96 may include code or instructions stored in a non-transitory machine-readable medium (e.g., the memory 14) and executed, for example, by the TCON 44 depicted in FIG. 5. The process 96 may begin with the TCON 44 receiving (block 98) image data. For example, the TCON 44 may receive image data from the image generating source 43 to be provided to the pixels 54 of the display 18.

The process 96 may then continue with the TCON 44 providing (block 100) the image data to pixels of a display according to a pixel inversion technique. For example, as discussed above with respect to FIG. 6, the TCON 44 may provide an applied voltage to the pixels 54 of the display 18 that alternate between a positive voltage polarity (e.g., +Vₚᵢₓₑₗ) and a negative voltage polarity (e.g., −Vₚᵢₓₑₗ) on a pixel by pixel basis. The process 96 may then continue with the TCON 44 tracking (block 102) the time a frame of image data is provided to the pixels of the display until a charge threshold value is reached. For example, as discussed above with respect to FIG. 5, the TCON 44 may include a counter 50 that is incremented and/or decremented corresponding to the duration of which each frame of a data is provided to the pixels 54 of the display 18 until a net pixel charge threshold (e.g., configurable positive and negative charge threshold) on the individual pixels 54 is reached.

The process 96 may then continue with the TCON 44 dividing (block 104) a frame period into a first frame period and a second frame period when the pixel charge threshold value is reached. For example, as previously discussed, the TCON 44 may divide a total frame period T into frame sub-periods T₁ and T₂ based on, for example, real-time (e.g., measured pixel charge imbalance accumulation data) pixel charge imbalance accumulation data or historical pixel charge imbalance accumulation data (e.g., data models of pixel charge imbalance accumulation generated from data measured or approximated over time).

The process 96 may then conclude with the TCON 44 providing (block 106) two or more frames of image data during the first frame period and the second frame period to reduce or eliminate a pixel charge imbalance accumulating on the pixels. For example, as discussed above in FIGS. 7, 8, and 9, the TCON 44 may repeat or alter a frame of image data by, for example, driving the pixels 54 with odd frames (e.g., positive frame) of image data during each of the frame sub-periods T₁ and T₂ positive when the accumulated pixel 54 charge (e.g., net accumulated pixel 54 charge) is approaching a negative polarity pixel charge threshold value, or by driving the pixels 54 with even frames (e.g., negative frame) of image data during each of the frame sub-periods T₁ and T₂ positive when the accumulated pixel 54 charge (e.g., net accumulated pixel 54 charge) is approaching a positive polarity pixel charge threshold value. In this way, the process 96 may thus reduce and/or substantially eliminate accumulated voltage and/or pixel charge imbalance on the pixels 54 of the display 18 when utilizing variable refresh rates, and, by extension, may reduce and/or substantially eliminate image artifacts based thereon that may become apparent on the display 18.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method of operating a display, comprising:
providing a first frame of image data via a processor to a plurality of pixels of the display during a first frame period corresponding to a first refresh rate;
providing a second frame of image data to the plurality of pixels of the display during a second frame period corresponding to a second refresh rate;
dividing the first frame period into a first frame sub-period and a second frame sub-period; and
driving the plurality of pixels of the display with the first frame of image data during the first frame sub-period and the second frame sub-period.

2. The method of claim 1, wherein providing the first frame of image data to the plurality of pixels of the display comprises providing a positive frame of image data to the plurality of pixels.

3. The method of claim 1, wherein providing the second frame of image data to the plurality of pixels of the display comprises providing a negative frame of image data to the plurality of pixels.

4. The method of claim 1, wherein dividing the first frame period into the first frame sub-period and the second frame sub-period comprises dividing the first frame period each time a charge on the pixels of the display reaches a pixel charge threshold value.

5. The method of claim 4, wherein dividing the first frame period into the first frame sub-period and the second frame sub-period comprises dividing the first frame period each time the charge on the pixels of the display reaches a positive polarity threshold value as the pixel charge threshold value.

6. The method of claim 4, wherein dividing the first frame period into the first frame sub-period and the second frame sub-period comprises dividing the first frame period each time the charge on the pixels of the display reaches a negative polarity threshold value as the pixel charge threshold value.

7. The method of claim 1, wherein dividing the first frame period into the first frame sub-period and the second frame sub-period comprises dividing the first frame period when the first refresh rate is greater than the second refresh rate.

8. The method of claim 1, wherein dividing the first frame period into the first frame sub-period and the second frame sub-period comprises dividing the first frame period into unequal frame sub-periods.

9. The method of claim 1, comprising dividing the second frame period into a third frame sub-period and a fourth frame sub-period.

10. An electronic device, comprising:
a processor configured to generate and transmit pixel data;
a timing controller (TCON) configured to receive the pixel data, and to:
supply an odd frame of the pixel data to pixels of the display during a first frame period at a first refresh rate;
supply an even frame of the pixel data to the pixels of the display during a second frame period at a second refresh rate;
divide the first frame period or the second frame period into a first frame sub-period and a second frame sub-period; and
supply the odd frame of the pixel data to the pixels during the first frame sub-period and the second frame sub-period when the second frame period is greater than the first frame period and supply the even frame of the pixel data to the pixels during the first frame sub-period and the second frame sub-period when the first frame period is greater than the second frame period; and
a display configured to display the pixel data.

11. The electronic device of claim 10, wherein the TCON is configured to supply the odd frame of the pixel data to the pixels during the first frame sub-period and the second frame sub-period to refresh the pixels at least twice during the first frame period when the second frame period is greater than the first frame period.

12. The electronic device of claim 10, wherein the TCON is configured to supply the even frame of the pixel data to the pixels during the first frame sub-period and the second frame sub-period to refresh the pixels at least twice during the second frame period when the first frame period is greater than the second frame period.

13. The electronic device of claim 10, wherein the TCON is configured to divide the first frame period or the second frame period into the first frame sub-period and the second frame sub-period to reduce or substantially eliminate an occurrence of image artifacts on the display.

14. The electronic device of claim 10, wherein first refresh rate comprises a refresh rate of n hertz (Hz) and the second refresh rate comprises a refresh rate of k Hz, wherein k is less than n.

15. The electronic device of claim 10, wherein the TCON is configured to adjust a cadence at which the odd frame is supplied at the first refresh rate and the even frame is supplied at the second refresh rate.

16. The electronic device of claim 10, wherein the TCON is configured to divide the first frame period or the second frame period into the first frame sub-period and the second frame sub-period when a touch is detected on the display.

17. A method for reducing image artifacts on an electronic display utilizing variable refresh rates, comprising:
receiving image data via a processor;
providing the image data to pixels of the electronic display according to a pixel inversion technique;
tracking a duration of which a frame of the image data is stored to the pixels of the display over a frame period until a threshold value is reached;
dividing the frame period into a first frame sub-period and a second frame sub-period; and
providing two or more frames of the image data during the first frame sub-period and the second frame sub-period to reduce or substantially eliminate a possible occurrence of pixel charge imbalance on the pixels of the display.

18. The method of claim 17, wherein tracking the duration of which a frame of the image data is stored to the pixels comprises tracking each time a charge on the pixels of the display reaches a positive polarity threshold value as the threshold value.

19. The method of claim 17, wherein tracking the duration in which a frame of the image data is stored to the pixels comprises tracking each time a charge on the pixels of the display reaches a negative polarity threshold value as the threshold value.

20. The method of claim 17, wherein providing two or more frames of the image data during the first frame sub-period and the second frame sub-period comprises driving each the pixels of the display with a voltage having a polarity opposite that of the pixels during a second frame period.

21. An electronic display, comprising:
display control logic configured to:
provide a first plurality of frames of image data to pixels of the electronic display at a first refresh rate;
provide a second plurality of frames of image data to the pixels of the electronic display at a second refresh rate;
divide a total frame period: T corresponding to the second refresh rate into a first frame sub-period: T₁ and a second frame sub-period: T₂; and
provide a first frame of the second plurality of frames of image data during the first frame sub-period: T₁ and a second frame of the second plurality of frames of image data during the second frame sub-period: T₂.

22. The electronic display of claim 21, wherein the first frame sub-period: T₁ comprises a minimum frame refresh period of the electronic display.

23. The electronic display of claim 21, wherein the first frame sub-period: T₁ is unequal to the second frame sub-period: T₂.

24. The electronic display of claim 21, wherein the first frame sub-period: T₁ is less than the second frame sub-period: T₂.

25. The electronic display of claim 21, wherein the first refresh rate comprises a refresh rate of approximately 120 hertz (Hz) or approximately 60 Hz.

26. The electronic display of claim 21, wherein the second refresh rate comprises a refresh rate of approximately 60 hertz (Hz) or approximately 30 Hz.

27. A non-transitory computer-readable medium having computer executable code stored thereon, the code comprising instructions to:
cause an electronic display to receive a first frame of image data to a plurality of pixels of the electronic display during a first frame period corresponding to a first refresh rate;
cause the electronic display to receive a second frame of image data to the plurality of pixels of the electronic display during a second frame period corresponding to a second refresh rate;
cause a timing controller (TCON) of the electronic display to divide the first frame period into a first frame sub-period and a second frame sub-period; and
cause the electronic display to receive the first frame of image data during the first frame sub-period and the second frame sub-period.
